(19) United States
(12) Patent Application Publication
(10) Pub. No.: US 2002/0023665 A1
(43) Pub. Date: Feb. 28, 2002

(54) Method and device for cleaning the cylinders of printing presses

(76) Inventors: Marco Corti, Lecco (IT); Riccardo Fumagalli, Oggiono (IT)

Correspondence Address: LARSON & TAYLOR, PLC, 1199 NORTH FAIRFAX STREET, SUITE 900, ALEXANDRIA, VA, 22314, US

(21) Appl. No.: 09/859,521

(22) Filed: May 18, 2001

(30) Foreign Application Priority Data
May 19, 2000 (IT) BO2000 A 000301

(51) Int. Cl. B08B 1/04

(52) U.S. Cl. 134/6

(57) ABSTRACT

The apparatus for cleaning the cylinders in printing presses is of the type comprising a cylindrical brush (3) parallel to the cylinder to be cleaned, which upon control is caused to rotate in a predetermined direction and is brought near to the cylinder so as to interfere with same which (apparatus) upstream of the contact zone between cylinder and brush comprises means for whetting the brush itself with cleaning liquid and which downstream of the said contact zone comprises means which interfere with the brush to remove from same the dirt removed from the cylinder which falls into an underlying tray (16) of collection and discharge. The apparatus is characterised by the fact that the dispensing means of the cleaning liquid comprise at least one row of nozzles (7) adapted to atomise finally, uniformly, and continuously on the brush the cleaning liquid mixed with air under pressure, there being provided that the atomisation is maintained for the whole duration of the cleaning cycle, so as to maintain the said brush constantly wetted, there being further provided that the means operating downstream of the zone of contact of the brush with the cylinder to be cleaned are such as to effect a strong cleaning of the said brush, in order that this latter arrives as clean as possible to the co-operation with the means for atomising the cleaning liquid, also for avoiding excesses of the said liquid on the cylinder to be cleaned.

### DESCRIPTION

The invention relates to a new method and device employing a rotary brush for cleaning the cylinders in printing presses.

There are known devices for cleaning the cylinders of printing presses, provided with a brush which is parallel to the cylinder to be cleaned, which upon control is caused to rotate and brought to interfere with the cylinder itself to subject same to a delicate cleaning operation, the said brush being sprayed, prior to its contact with the cylinder, with cleaning liquids, usually consisting of water and/or a solvent. Downstream of the contact zone of the brush with the cylinder, it is also known to provide for the interference of the brush with the usually rounded edge of a bar, in order to remove from the brush itself the dirt which falls into an underlying collection and discharge tray. It is also known to provide for an alternate motion in axial direction of the brush, so as to uniformly distribute onto the said brush and onto the cylinder the cleaning liquid.

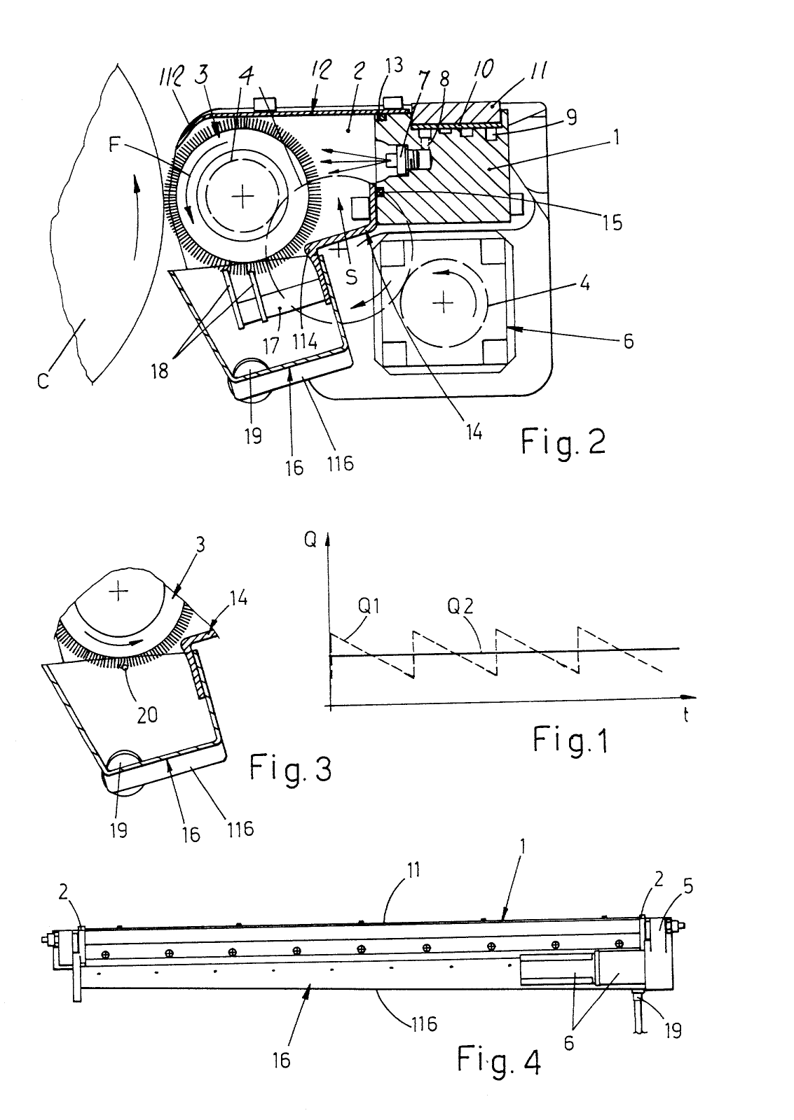

Presently the cleaning liquid is distributed onto the brush in a cursory and cyclic manner, with sprays having a duration of about one tenth of a second, as indicated by the dash-line curve Q1 of the graph of FIG. 1, where on the abscissa there are indicated the times “t” and on the ordinate there are indicated the quantities “Q” of liquid which wet the brush. The peaks of the curve Q1 indicate the instants of the sprays. This mode of operating leads firstly to excesses of liquid on the cylinder to be cleaned, which may drop without possibility of control, and then it leads to deficiencies of liquid which render aggressive the contact of the brush with the cylinder and which can damage the cylinder itself. For this reason the means which provide for the cleaning of the brush downstream of the zone of contact with the cylinder are presently means for a soft cleaning, such as to remove the macroscopic particles of dirt, but such as to leave at the same time the more possible of the cleaning liquid, so that it returns back in circulation to get saturated with dirt. To this inconveniences there must be then added the constructional complexities due to the axial alternate motion of the brush.

The invention intends to obviate to these and other inconveniences of the known art by means of the following method. For the whole duration of the cleaning cycle of the cylinder, onto the brush there is uniformly atomised a minimum, suitable, continuous and preferably constant quantity of cleaning fluid formed by air under pressure and by detergent liquids, as diagrammatically indicated by line Q2 of FIG. 1, so that the brush itself results to be uniformly wetted on its whole length, without the need of axial displacement as in the known art. Downstream of the zone of contact with the cylinder, means are then provided for effecting a vigorous cleaning of the brush, in such a manner that all the dirty liquid which the brush removes from the cylinder is taken away from the said brush, so as to avoid situations of excess or of deficiency of liquid on the cylinder, as instead it happens in the known prior art.

Further characteristic features of the invention, and the advantages deriving therefrom, will appear better evident from the following description of a preferred embodiment of same, made merely by way of non limiting example in the Figures of the attached sheet of drawings, in which, besides the already considered FIG. 1, it is noted that:

FIG. 2 is a side view and with parts in section of the novel device in the active condition of intervention on the cylinder of the printing press;

FIG. 3 shows part of the device of FIG. 2 according to a constructive variation of the means for cleaning the brush;

FIG. 4 is a front elevation view of the device, taken from the front opposed to the one directed against the cylinder to be cleaned.

In FIG. 2, reference letter C indicates the cylinder to be cleaned, for example the rubber cylinder parallelly to which there is arranged the cleaning apparatus which comprises a bar 1 fixed by its extremities to shoulders 2 connected to motion means, not shown, which upon control move the said apparatus near and away with respect to the said cylinder C. The shoulders 2 rotatably support by their ends the cylindrical brush 3 which is parallel to said bar 1 and which by means of the end gear train 4 housed in the case 5 of FIG. 4, is connected to the gear reducer 6 arranged below the said bar 1 and by means of which the said brush is caused to be rotated continuously and at a correct speed in the predetermined direction indicated for example by arrow F in FIG. 2.

On the front of the bar 1 which is facing the brush 3 there is mounted a row of atomising nozzles 7 which are directed against the said brush and are spaced apart between them in such a manner as to interest the brush itself uniformly for its whole length. As described in the Italian patent IT 1 286 206 (corresponding to EP 0 916 492) and in the patent application PCT/EP 01/00267 belonging to the same applicants, the nozzles 7 are connected by means of bores 8 to channels 9 obtained by milling onto a flat face of the bar 1 onto which there is thereafter laid a flat packing 10 and there is fixed by means of screws, not shown, a cover plate 11 which transforms the said canalisations into proper ducts. The said channels are connected in symmetrical manner to other feed channels which branch off between each other, bifurcate and progressively are reduced by number until they meet together into a single feed duct for the cleaning fluid mixture composed of air under pressure and of a liquid, opening into an orifice arranged for example at one extremity of the bar 1. Each bifurcation of the said ducts is substantially Y-shaped, which is obtained along a straight path and the ducts resulting from the bifurcation are structured in such a manner as to offer a substantially equal resistance to the flow of the fluid mix, so that this latter is divided into substantially equal quantities at each bifurcation. The bifurcations are in such a number that each final duct resulting from a bifurcation, feeds one single nozzle, so as to ensure a balanced distribution of the cleaning fluid mixture between the various nozzles of the apparatus. By this solution it is possible to ensure a controlled, continuous and constant feeding of cleaning fluid to the brush 3 as indicated diagrammatically by the line Q2 of the graph of FIG. 1, in order to maintain the brush itself uniformly wetted with water and/or with solvent.

The chamber S between the bar 1 provided with the nozzles and the brush 3, is closed at its ends by the shoulder 2, is closed at the top by a wall 12 fixed by its ends on the said shoulders 2 and fixed onto said bar 1 with the interposition of a sealing packing 13 and is such as to cover the brush 3 with a portion 112 which is downwardly curved, which lets free the front of the said brush intended to contact the cylinder C to be cleaned. The above mentioned chamber S is closed at its bottom by a wall or gutter 14 which is substantially Z-shaped, which comes to a short distance from brush 3 and which is fixed with the interposition of a packing 15 onto the lower portion of the front of bar 1 on which there are mounted the nozzles 7. All the liquid atomised by the nozzles 7, thanks to the said closed shape of the chamber S, is compelled to invest the brush 3 in a uniform manner without localised excesses and is firstly from said brush transferred onto the cylinder C to be cleaned, and then from the same brush it is removed from the said cylinder, together with the dirt which the liquid will be able to solve. In this connection it is to be noted that the atomisation of the cleaning liquid effected by the nozzles 7 is such that the liquid itself comes to be deposited in the form of very small drops on the bristles of the brush, thus wetting the said brush according to a distributed shape with a spot mapping, reticular or discrete, which is variable upon the time, so that the point which before was wetted then can be dry or viceversa. The liquid therefore is deposited on the brush in the form of very small drops uniformly distributed along the whole width of the brush itself so that it happens that to a bristle with liquid drops statistically there follows a nearby bristle which is without liquid, so that the wetted bristle wets the cylinder, while the bristle which was not wetted takes off from the cylinder the liquid conveyed by the preceding bristle and takes off the dirt which the liquid itself has succeeded in solving and/or in softening.

Below the brush 3 and for its whole length there is provided a rectilinear tray 16 secured to the shoulders 2 and/or to the gutter 14 which enters into the said tray and which by means of supports 17 carries flat and rectilinear doctors 18, parallel to the brush and which with their edge interfere with the brush itself in order to clean it of all dirt and of all liquid removed from cylinder C. The portion of the brush 3 which is progressively brought into contact with the cylinder C is thus always clean and it does not carry onto the cylinder itself traces of dirt or quantities of cleaning liquid which would result in excess if they were added to the quantity progressively fed by the nozzles 7.

The dirt and the liquid removed by the doctors 18, which can be in a number different with respect to what illustrated, fall into the tray 16 the bottom of which 116 is longitudinally inclined (FIG. 4), so that by gravity the liquid with the dirt flows towards the lower extremity of the tray which is provided with a discharge opening 19.

It is to be understood that contrarily to what illustrated also the edge 114 of the gutter 14 may act as finishing doctor, the whole in a manner which is conceivable and easily to be realised by the persons skilled in the art.

The shape of the tray 16 can be different from the one shown in FIG. 2, also to consent to the said tray to collect possible spray of dirt and liquid which come from the zone in which the brush 3 comes out of contact from the cylinder C to be cleaned. It is to be understood that the direction of rotation of cylinder C can be, differently, concordant with the one of brush 3. It is then understood that means different from those described can be adopted to perform a strong cleaning of the brush above the tray 16 for collecting and discharging the dirt. In combination or alternately to the doctors 18 there can be for example used harmonic wires or cables 20 as from the example of FIG. 3, anchored for example by their ends to the head portions of the tray 16 and parallel to the brush, so as to realise scraping elements of the brush itself which result to be more easily self-cleaning thanks to their small and rounded section, thanks to the force of gravity, and thanks to the vibrations to which the cables are subjected from the physical contact with the brush.

It is to be understood that the continuous dispensing of the cleaning fluid mix effected by the nozzles 7 can practically not present a path perfectly linear as indicated by the line Q2 of the graph of FIG. 1, since during different moments of the cleaning cycle the mix can be modified in the quantity of liquid dispersed in the stream of air under pressure and therefore can be more or less rich with liquid. For example it is not to be excluded that at the end of the cycle, the nozzles 7 atomise a mixture which is richer with liquid in order to ensure a quick final cleaning of the brush.

1. Method for cleaning the cylinders of printing presses by means of a rotary brush, characterised by the following phases:
Uniformly distributed atomisation onto the brush upstream of the zone of contact of same with the cylinder to be cleaned, of a continuous quantity of fluid cleaning mixture formed by air under pressure and by one or more detergent liquids, so as to wet the brush uniformly along the whole length or width of its useful surface and for all the duration of the cleaning phase;
Strong cleaning of the brush downstream of the zone of contact with the cylinder to be cleaned, so that the brush itself returns into rotation cleaned, also for avoiding excesses of liquid on said cylinder.

2. Method according to claim 1, in which the quantity of liquid which composes the cleaning mixture atomised onto the brush is constant during the whole cycle of cleaning of the cylinder.

3. Method according to claim 1, in which the fluid cleaning mixture can vary in the concentration of liquid during the cleaning cycle of the cylinder.

4. Apparatus for cleaning the cylinders in printing presses, of the type comprising a cylindrical brush (3) parallel to the cylinder to be cleaned, which upon control is caused to rotate in a predetermined direction and is brought near to the cylinder so as to interfere with same which (apparatus) upstream of the contact zone between cylinder and brush comprises means for wetting the brush itself with cleaning liquid and which downstream of the said contact zone comprises means which interfere with the brush to remove from same the dirt removed from the cylinder which falls into an underlying tray (16) of collection and discharge, characterised by the fact that the dispensing means of the cleaning liquid comprise at least one row of nozzles (7) adapted to atomise finally, uniformly, and continuously on the brush the cleaning liquid mixed with air under pressure, there being provided that the atomisation is maintained for the whole duration of the cleaning cycle, so as to maintain the said brush constantly wetted, there being further provided that the means operating downstream of the zone of contact of the brush with the cylinder to be cleaned are such as to effect a strong cleaning of the said brush, in order that this latter arrives as clean as possible to the co-operation with the means for atomising the cleaning liquid, also for avoiding excesses of the said liquid on the cylinder to be cleaned.

5. Apparatus according to claim 4, in which the nozzles (7) are connected to a respective channel (9) obtained in the rectilinear bar (1) which carries the said nozzles and on its turn connected in a symmetrical manner to other channels arranged branching off with one another, which bifurcate as a “Y” and which progressively are reduced in number until they connect into a single feeding duct for the fluid mixture composed of air under pressure and of liquid, so as to ensure an even distribution of the said mixture between all the nozzles of the dispensing bar.

6. Apparatus according to claim 4, in which the dispensing nozzles (7) of the fluid cleaning mixture and the portion of brush directed towards said nozzles are located inside a chamber (S) which is substantially closed towards the exterior, which causes all the mixture dispensed by said nozzles to wet the said brush, the said chamber being closed on the opposed fronts by the brush and by the bar (1) with the nozzles, being closed at its extremities by the shoulders (2) which support the said bar and the brush (3), and being closed at the top and at the bottom by walls (12, 14) fixed to the said bar and to the shoulders and located in close proximity to the brush.

7. Apparatus according to claim 6, in which the means for performing the strong cleaning of the brush (3) consist of flat doctors (18) contacting the brush itself by their edge and secured by means of supports (17) to the lower closure wall (14) of the chamber (S) of atomisation of the cleaning mixture onto the same brush.

8. Apparatus according to claim 4, in which the wall (14) which closes at its bottom the chamber (S) of atomisation of the cleaning liquid onto the brush, can be brought into slight interference with the brush itself by one edge (114) which assumes the function of finishing doctor.

9. Apparatus according to claim 4, in which the means for the strong cleaning of the brush (3) consist of harmonic wires or cables (20) tensioned and arranged parallelly to the said brush, which provide to their self-cleaning thanks to their reduced and rounded section and thanks to the vibration to which they are subjected by the interference with the brush.

10. Apparatus according to claim 4, in which the tray (16) for the collection and the discharge of the dirt and of the liquid removed by the cleaning brush (3) has its bottom (116) longitudinally inclined and carries on its extremity presenting a greater height a bottom hole (19) for discharging the collected fluid.
